(19) United States
(12) Patent Application Publication
(10) Pub. No.: US 2025/0312630 A1
(43) Pub. Date: Oct. 9, 2025

(54) FALL-ARREST DEVICES

(71) Applicant: International Safety Components Ltd, Gwynedd (GB)

(72) Inventor: KEVIN BROWN, GWYNEDD (GB)

(73) Assignee: International Safety Components Ltd, Gwynedd (GB)

(21) Appl. No.: 18/865,248

(22) PCT Filed: Feb. 9, 2023
(86) PCT No.: PCT/GB2023/000005

§ 371 Date: Nov. 12, 2024

(30) Foreign Application Priority Data
Feb. 9, 2022 (GB) GB2201647.1
Feb. 8, 2023 (GB) GB2301798.1

(51) Int. Cl. A62B 35/00

(52) U.S. Cl. CPC A62B 35/0093; A62B 35/0037

(57) ABSTRACT

A fall-arrest device (1,26) for use during rope-climbing activities, the device comprising or including a housing (5) for rotatably receiving therewithin a brake wheel (11,30) supported on an axle (20), the housing including anchor means (3,4) permitting connection of the device to a user thereof, the brake wheel having peripheral teeth (17,29) adapted to, in use, engage with a mid-portion of an anchored safety rope (2), the housing being openable by a gate (5a) through which to receive part of the anchored safety rope and thereafter being closable to trap the safety rope between the teeth of the brake wheel and a rope bearing thrust surface (18,28) on or in the housing, the brake wheel having associated automatic locking means (23,24), preventing rotation of the brake wheel about the axle above a nominal rate of rotation, the brake wheel locking means being spring-biased (14) to a stored position when the brake wheel is stationary or rotates below the nominal rate during use, the brake wheel locking means (24) being movable from the stored position to an operable position in which it engages with one or more locking formations (23) preventing further rotation of the brake wheel about the axle, the brake wheel axle being drivingly secured at at least one end thereof to a respective pinion (13a, 13b) having teeth extending radially therefrom, the teeth of the or each pinion being engageable with a respective toothed rack (12a, 12b,27) fixed to the inside of the housing whereby to permit the brake wheel to assume a path of movement further towards the thrust bearing surface such that when rotation of the brake wheel exceeds the nominal rate and has been arrested, such that when the rate of rotation of the brake wheel relative to the anchored rope exceeds the nominal rate, the axle and brake wheel are progressively driven further towards the thrust bearing surface to thereby cause the teeth of the brake wheel to progressively bite into the rope and arrest downward movement of the device along the rope.

This invention relates to fall-arrest devices of the type used during rope-climbing activities including, without limitation, the activities of rope access workers. In this patent specification the term “rope” is intended to include any suitably flexible filament or line onto which formations such as teeth can be clamped whereby to prevent relative movement therealong.

### BACKGROUND OF THE INVENTION

Known kinds of fall-arrest devices (respectively D1 and D2) are marketed by Big Bang SAS (under their trading name of Petzl) at:—https://www.petzl.com/INT/en/Professional/Mobile-fall-arresters/ASAP https://www.petzl.com/INT/en/Professional/Mobile-fall-arresters/ASAP-LOCK

Both of the D1 and D2 devices utilise a toothed wheel with an integrated inertia reel mechanism within a housing. The wheel of the inertia reel mechanism is mounted on a ‘swing arm’ which is hinged to pivot inside the housing. However, the use of a swing arm type of arrangement makes the overall device relatively bulky in view of the length of the swing arm and number of components required.

The present invention is derived from the realisation that there is a need for a more compact and simpler arrangement with fewer parts, potentially leading to cost savings in terms of manufacture and also being relatively light in weight.

### SUMMARY OF INVENTION

According to the invention there is provided a fall-arrest device for use during rope-climbing activities, the device comprising or including a housing for rotatably receiving therewithin a brake wheel supported on an axle, the housing including anchor means permitting connection of the device to a user thereof, the brake wheel having peripheral teeth adapted to, in use, engage with a mid-portion of an anchored safety rope, the housing being openable by a gate through which to receive part of the anchored safety rope and thereafter being closable to trap the safety rope between the teeth of the brake wheel and a rope bearing thrust surface on or in the housing, the brake wheel having associated automatic locking means preventing rotation of the brake wheel about the axle above a nominal rate of rotation, the brake wheel locking means being spring-biased to a stored position when the brake wheel is stationary or rotates below the nominal rate during use, the brake wheel locking means being movable from the stored position to an operable position in which it engages with one or more locking formations preventing further rotation of the brake wheel about the axle, the brake wheel axle being drivingly secured at at least one end thereof to a respective pinion having teeth extending radially therefrom, the teeth of the or each pinion being engageable with a respective toothed rack fixed to the inside of the housing whereby to permit the brake wheel to assume a path of movement further towards the thrust bearing surface such that when rotation of the brake wheel exceeds the nominal rate and has been arrested, the arrangement being such that when the rate of rotation of the brake wheel relative to the anchored rope exceeds the nominal rate to thereby cause the brake wheel to be rotationally locked to the axle, the axle and brake wheel are progressively driven further towards the thrust bearing surface to thereby cause the teeth of the brake wheel to progressively bite into the rope and arrest downward movement of the device along the rope.

With this arrangement the brake wheel is initially free to rotate about the axle as it lightly engages the anchored safety rope and is pulled up or down at a nominal speed by virtue of being attached to a user of the device via a safety line, but in the event of the user falling, such as due to failure of part or all of a primary safety-rope system, the attachment of the device to e.g. a climber automatically pulls the rope-arrest device downwards at much greater speed until the rate of rotation of the brake wheel exceeds the nominal value beyond which the brake wheel locking mechanism becomes engaged, to thereafter cause the locked brake wheel to move further towards the rope bearing thrust surface to thereby cause the teethe of the brake wheel to bite progressively further into the rope and arrest the fall.

Conveniently, the housing is in the form of a two-part frame having a front and rear between which are mounted the brake wheel and related components. The brake wheel locking mechanism may conveniently comprise one or more spring-biased pawls rotatably mounted on pawl pins fixed to the brake wheel, either directly or indirectly, the free end of the or each pawl being engageable with locking formations drivingly connected to the brake wheel axle whereby to prevent further rotation of the brake wheel. Alternatively, the brake wheel locking means may comprise one or more bolts slidable radially outwardly from the axis of rotation of the brake wheel and engageable with a locking formation secured for rotation with the axle to thereby fix the wheel to the axle.

### BRIEF DESCRIPTION OF THE DRAWINGS

The invention will now be described, by way of example only, with reference to the accompanying drawings in which:

FIG. 1 is a perspective view of a first embodiment of rope-arrest device 1 according to the invention attached to a safety rope 2,

FIG. 2 is an exploded view of the device of FIG. 1,

FIG. 3 is a perspective view of the device of FIG. 1 in its open condition,

FIG. 4 is a perspective view of the brake wheel of the device of FIG. 1,

FIG. 5 is an exploded view of the brake wheel of FIG. 4,

FIG. 6 is a rear view of the brake wheel of FIG. 4 mounted on part of the device of FIG. 1,

FIG. 7 is a perspective view of the device of FIG. 6,

FIG. 8 is a front perspective view corresponding to that of FIG. 1 of a second embodiment of the invention but without showing the captured anchor rope,

FIG. 9 is an exposed front view of the embodiment of FIG. 8 showing the brake wheel in its fully engaged position

FIG. 10 is an exposed front view of the embodiment of FIG. 8 showing the brake wheel in its fully disengaged position, and

FIG. 11 is an exposed partially exploded view of the embodiment of FIG. 8 with the brake wheel in its fully disengaged position.)

### DETAILED DESCRIPTION OF THE DRAWINGS

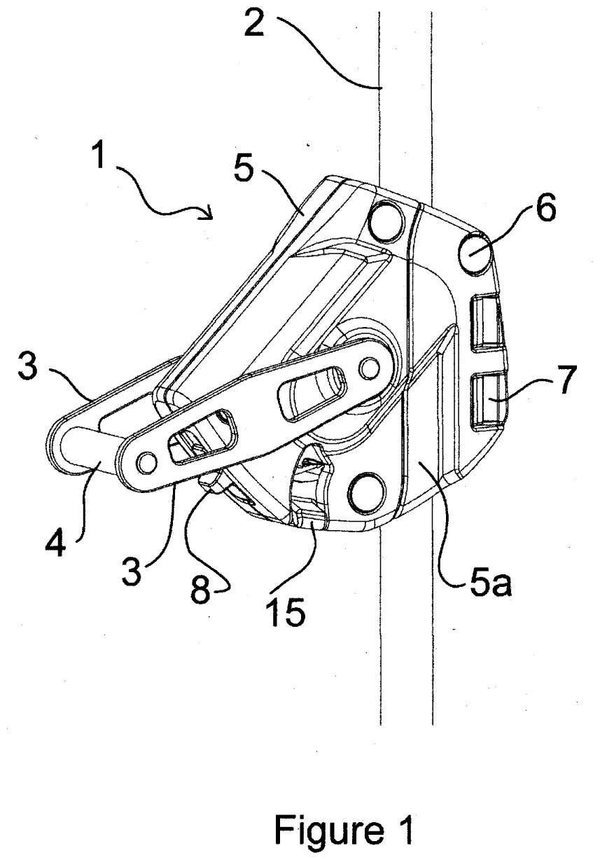

Referring firstly to FIG. 1 there is shown a first embodiment of a fall-arrest device 1 releasably attached to a safety rope 2 itself attached at its upper end (not shown) to an anchor point. The device 1 includes a yoke 3 separated by a rigid bar 4 defining, in use, a means by which a user of the device can attach a safety line to a climbing harness worn by the climber.

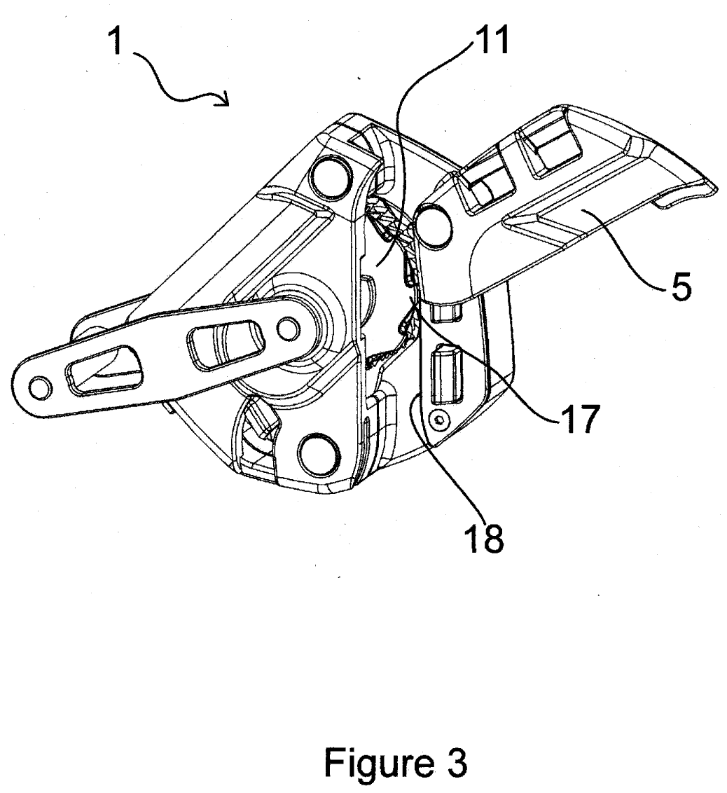

The device 1 is comprised of a two-piece housing 5 which includes a gate 5a on one side openable about a swivel pin 6 and closable to the locked position shown in FIG. 1 by means of a gate lock 7 in the form of a spring-loaded detente button, depression of which button releases the gate 5a so that it can thereafter be opened in the manner as shown in FIG. 3 for sideways insertion and removal of the rope 2. The device 1 can selectively be fixed to the rope 2 by the use of a slidable locking lever 8 and brake pawl 15, a feature particularly useful when the climber is working at height in a fixed position.

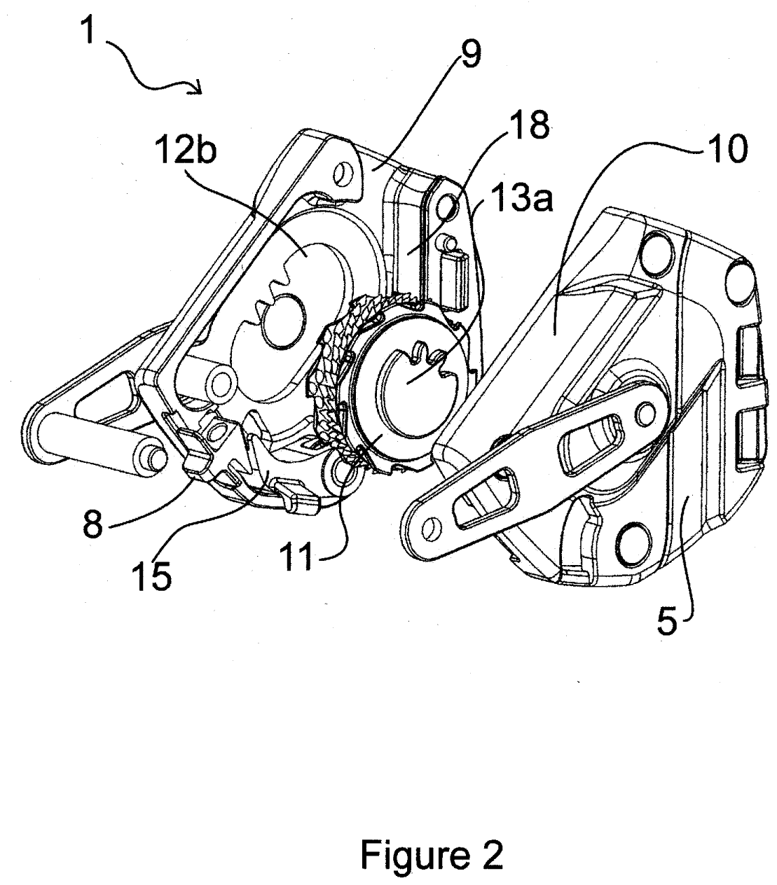

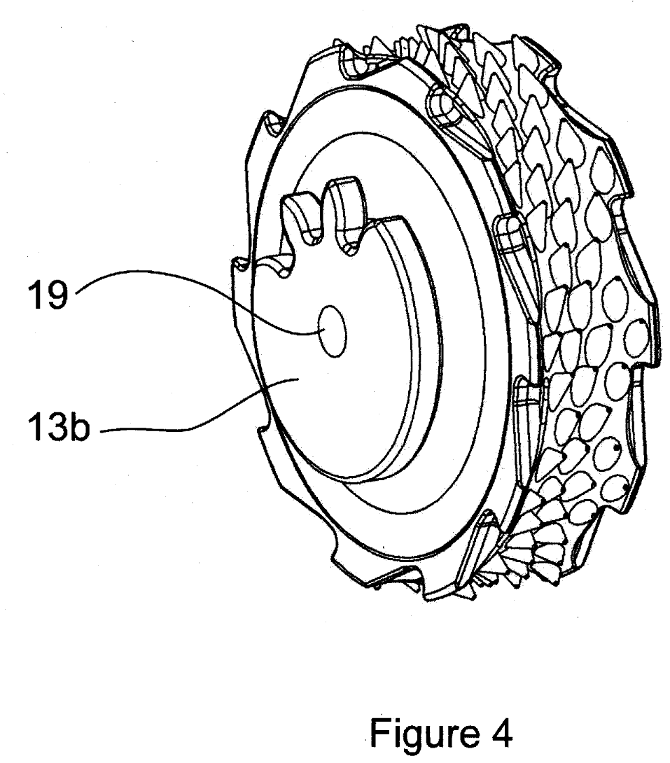

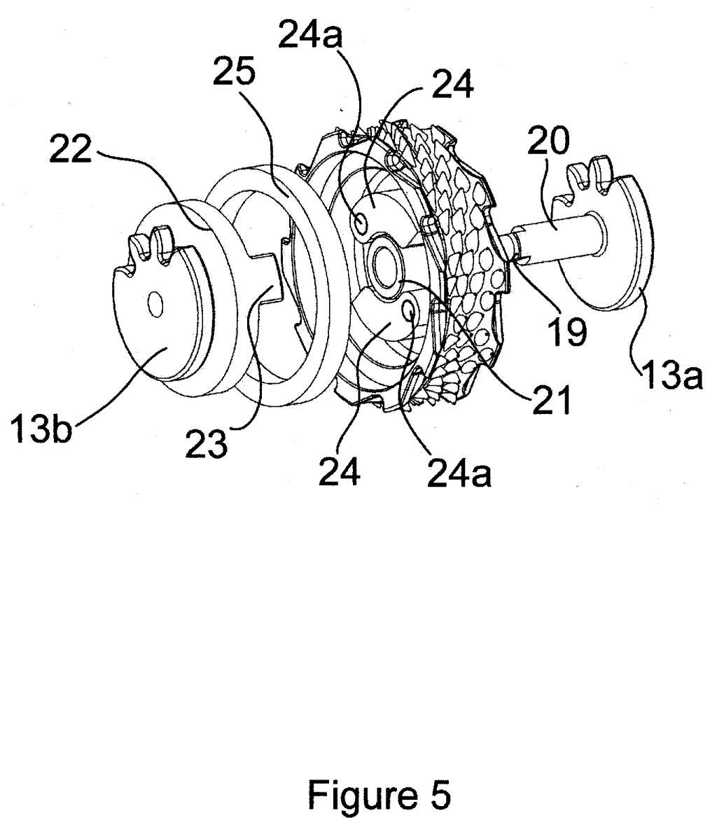

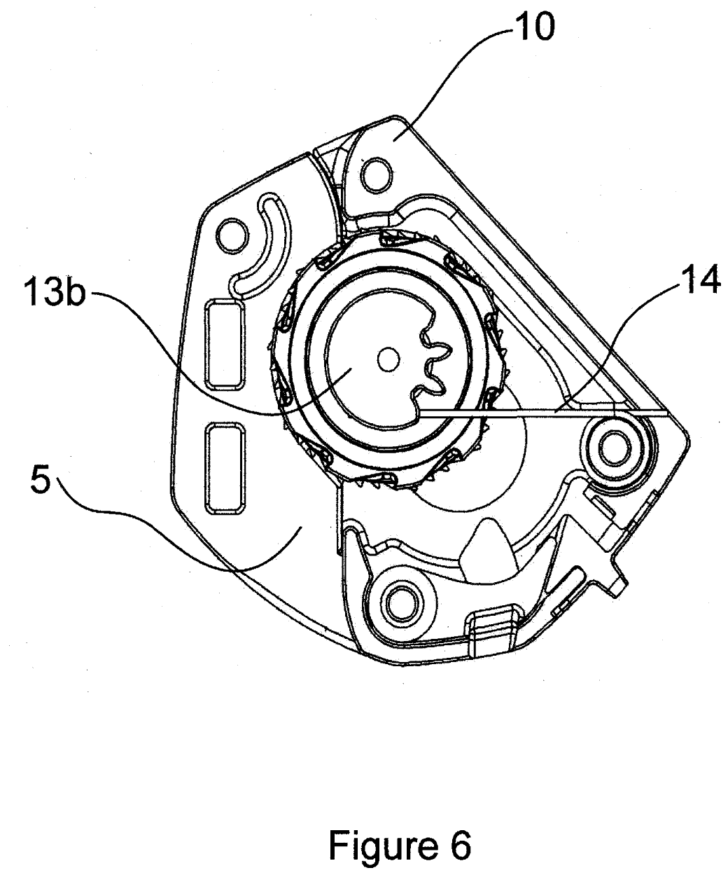

FIG. 2 shows an exploded view of the device of FIG. 1 in which it will be seen that the device 1 has a back plate 9 and a front plate 10 between which is disposed a toothed brake wheel 11 as described more fully with reference to FIGS. 4 and 5. Fixed to the back plate 9 is a toothed rack 12, a counterpart of which (not shown) is fixed to the inside of the front plate 10. Each toothed rack 12 is co-operable with a respective toothed pinion 13a,b on respectively opposite sides of the brake wheel 11. As shown in FIGS. 6 & 7, fixed to the front plate 10 is a torsion spring 14, by which to bias the brake wheel to the position 15 shown in FIG. 3. The slidable brake lever 8 is integral with a brake pawl 15 insertable in one of the teeth 17 of the brake wheel 11 with which to arrest rotation of the brake wheel in a manner to be described.

FIG. 3 shows the device 1 in its open condition in which the gate 5 has been swivelled anticlockwise to reveal the brake wheel 11 resting by one of its teeth 17 against a thrust bearing surface 18. The brake wheel 11 is biased by the torsion spring 14 to rest in this position but can be manually moved away from the bearing surface 18 in order to facilitate insertion of the rope 2 therebetween.

FIGS. 4 & 5 respectively show assembled and exploded views of the brake wheel 11 and pinions assembly 13 in which for clarity the pinion at the rear is marked as 13b and the pinion at the front is marked as 13a. FIG. 4 is a perspective view of the brake wheel 11 and respective pinion 13b and FIG. 5 is an exploded view from the rear. It will be seen that the pinions 13a,b are each fixed to and rotatable with a central axle 19, the rear pinion 13b being integral with a hub 20 rotatably receivable within a centrally-disposed bore 21 in the brake wheel 11, whereas the rear pinion 13b is fixed to a collar 22 having respectively opposite drive lugs 23 such that when they are driven they rotate the axle 19 and respective pinions 13a,b. The drive lugs 23 are engageable with a pair of pawls 24 spring-biased to the position shown when the brake wheel 11 is rotating about the hub 20 at a speed above a nominal level by virtue of the trailing arms of the pawls 24 swinging radially outwardly due to centripetal force to thereafter engage with the drive lugs 23.

A waterproof seal 25 ensures that when assembled in the manner shown in FIG. 4 the pawls 24 are protected against the ingress of dust or dirt which could otherwise adversely affect operation of the pawls 24.

When the brake wheel 11 is stationary or rotating by only a nominal amount corresponding to being pulled by a climber using the device 1 via a safety line the pawls 24 remain in the rest position shown in FIG. 5, in which position the climber has the option to releasably lock the device 1 to the rope 2 while working at a particular height, such as by moving the device 1 to a position on the rope 2 slightly above the climber and temporarily fixing it there by the locking lever 8 and brake pawl 15 such that in the event of a fall the safety line to which it is attached to the climber's harness is at or almost at its fully extended length. At such position and upon a fall occurring the extent of the climber's fall is limited before the device 1 arrests the fall. This prevents a situation arising whereby the climber is effectively always dragging or pulling the device 1 when working at a particular height, bringing with it the risk that if a primary safety rope system fails the device 1 is in its lowest possible position relative to the climber such that the extent of the climbers' fall is effectively twice the length of the safety line, only after which does the device 1 arrest the fall and, when doing so, due to the speed of fall the climber experiences a much larger jolt or jerk than would otherwise be the case, thereby increasing the possibility of failure of the fall-arrest system. Thus, the provision of a mechanism to lock the device 1 at a particular position on the rope 2 is an important safety feature.

FIGS. 6 & 7 respectively show perspective and rear views of the front plate 10 and gate 5 showing how the torsion spring 14 is received between the inside hub of the pinion 13b and the outside of the brake wheel 11 to bias the assembly towards the position shown against the thrust bearing surface 18 shown in FIG. 3, from which position the assembly can be moved sideways against the bias of the spring 14 in order to insert the anchored rope 2 therebetween.

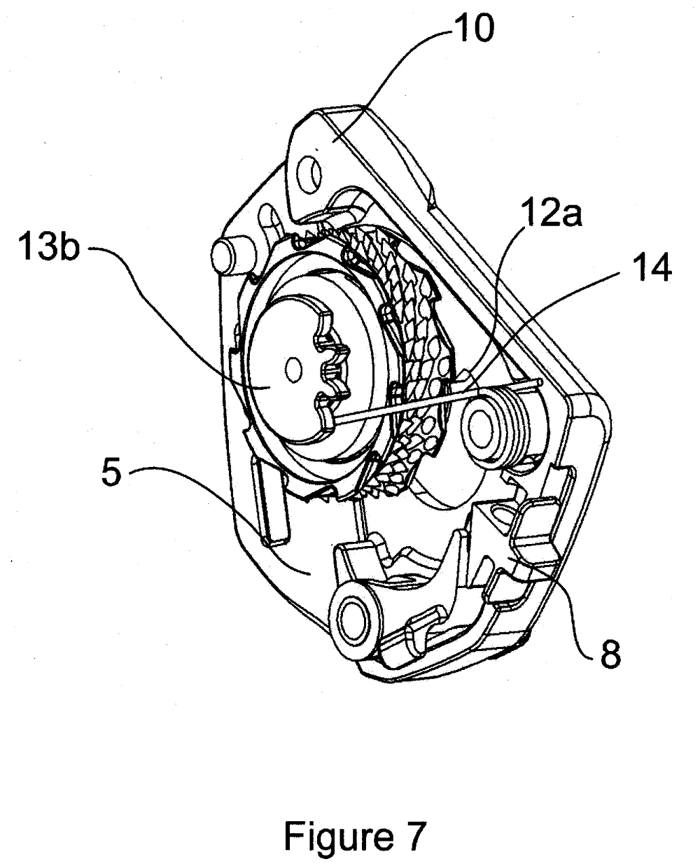

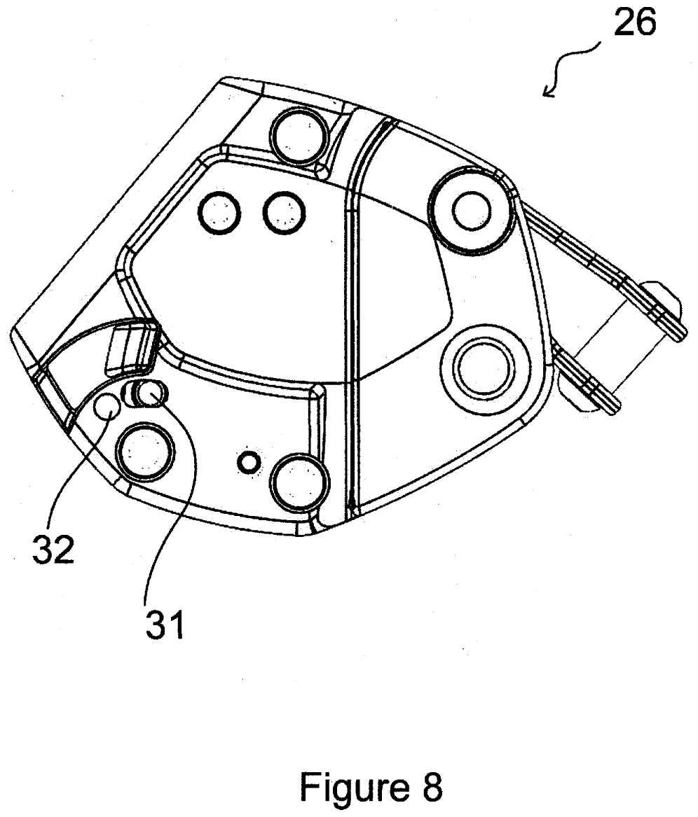

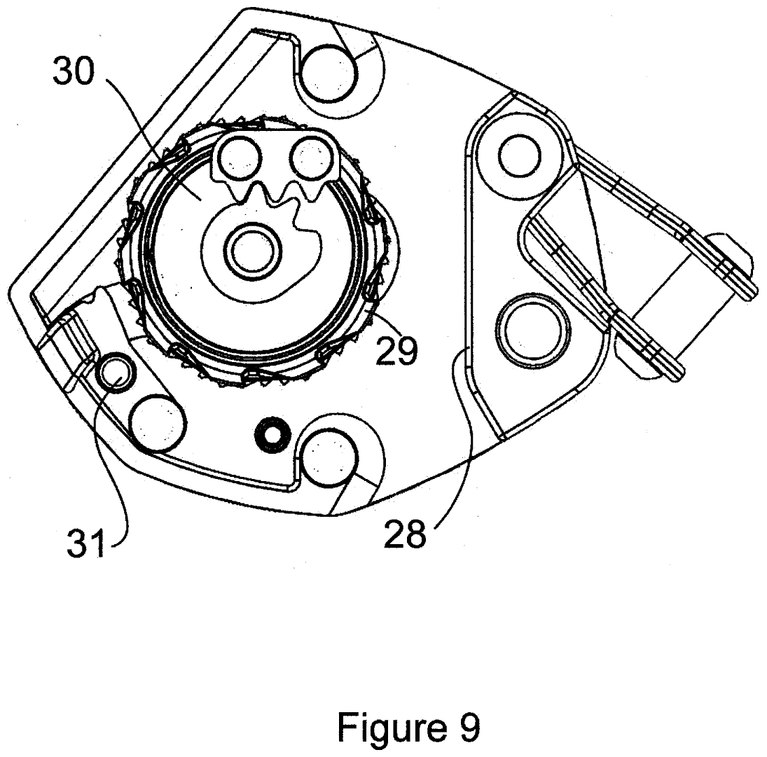

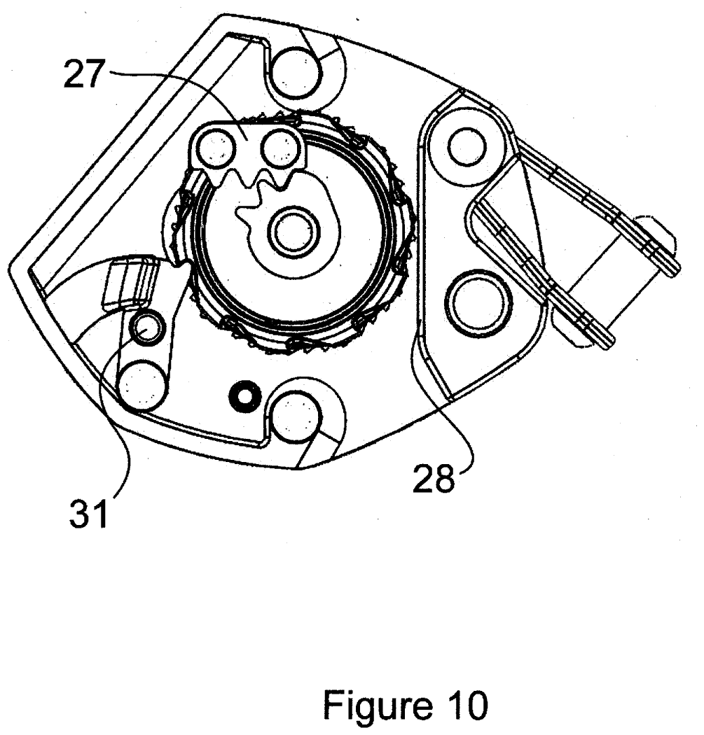

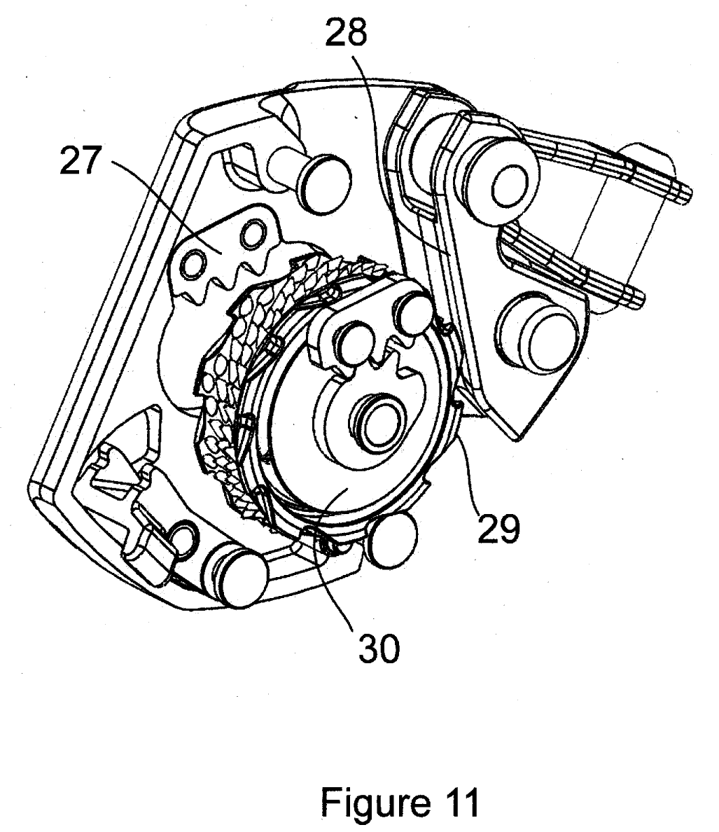

FIGS. 8 to 11 show a second embodiment of fall-arrest device 26 having two notable differences, the first being that, unlike the position of the toothed rack's 12a, 12b shown in FIGS. 7 and 2 respectively, which are each generally arranged around 45° relative to the rope bearing thrust surface 18, in this instance the toothed rack's 27 (only one of which is shown in FIGS. 9 & 11) are arranged generally perpendicular to the rope thrust bearing surface 28. This arrangement ensures that the rope does not become permanently wedged between the teeth 29 of the brake wheel 30 to the extent that the fall arrest device 26 cannot easily be moved upwards after a user of the device has re-established a safe position following the fall and is effectively locked to the anchor rope.

The other difference from the first embodiment of the invention is that instead of the locking lever 8 arrangement used in the first embodiment of the invention for locking the brake pawl 15 in its non-active position, a spring-loaded detente ball 31 operable in the manner of a pushbutton, which cooperates with a bore 32 having a smaller diameter but sufficient to allow part of the ball 31 to protrude therefrom, thereby permitting locking and the locking to be achieved by the simple expedient of pressing the ball with a finger. This is a less obtrusive arrangement to that shown and described with reference to the first embodiment of the invention and is therefore less likely to become snagged or accidentally operated and more readily operated in inclement weather conditions or when wearing gloves.

As will be appreciated, the fall-arrest devices 1, 26 of the invention are potentially more compact than the design of D1 and D2 because they do not utilise a swing-arm type of arrangement of the prior art and are more easily manufactured, with fewer moving parts.

1.-9. (canceled)

10. A fall-arrest device for use during rope-climbing activities, comprising:
a housing for rotatably receiving therewithin a brake wheel supported on an axle;
the housing including anchor means permitting connection of the device to a user thereof;
the brake wheel having peripheral teeth adapted to, in use, engage with a mid-portion of an anchored safety rope;
the housing being openable by a gate through which to receive part of the anchored safety rope and thereafter being closable to trap the safety rope between the teeth of the brake wheel and a rope bearing thrust surface on or in the housing;
the brake wheel having associated automatic locking means, preventing rotation of the brake wheel about the axle above a nominal rate of rotation;
a brake wheel locking means being spring-biased to a stored position when the brake wheel is stationary or rotates below the nominal rate during use;
the brake wheel locking means being movable from the stored position to an operable position in which it engages with one or more locking formations preventing further rotation of the brake wheel about the axle;
the brake wheel axle being drivingly secured at at least one end thereof to a respective pinion having teeth extending radially therefrom;
the teeth of the or each pinion being engageable with a respective toothed rack fixed to the inside of the housing whereby to permit the brake wheel to assume a path of movement further towards the thrust bearing surface such that when rotation of the brake wheel exceeds the nominal rate and has been arrested, such that when the rate of rotation of the brake wheel relative to the anchored rope exceeds the nominal rate, the axle and brake wheel are progressively driven further towards the thrust bearing surface to thereby cause the teeth of the brake wheel to progressively bite into the rope and arrest downward movement of the device along the rope.

11. The fall arrest device according to claim 10, wherein the housing is in the form of a two-part frame having a front plate and rear plate between which are mounted the brake wheel and related components.

12. The fall-arrest device according to claim 11, wherein the brake wheel locking mechanism comprises one or more spring-biased pawls rotatably mounted on pawl pins fixed to the brake wheel, either directly or indirectly, the free end of the or each pawl being engageable with locking formations drivingly connected to the brake wheel axle whereby to prevent further rotation of the brake wheel.

13. The fall-arrest device according to claim 11, wherein the brake wheel locking means comprises one or more levers slidable radially outwardly from the axis of rotation of the brake wheel and being engageable with a respective locking formation secured for rotation with the axle to thereby prevent rotation of the wheel.

14. The fall-arrest device according to claim 10, wherein the or each toothed rack is disposed at an angle of generally 45° relative to the thrust bearing surface.

15. The fall-arrest device according to claim 14, wherein the or each toothed rack is disposed at an angle of generally 90° relative to the thrust bearing surface.

16. The fall arrest device according to claim 10, wherein the brake wheel locking means includes a detente button operable with the locking lever, depression of which frees the lever from its locking engagement with the brake wheel and axle.

17. The fall arrest device according to any claim 16, wherein the brake wheel locking means comprises a slidable locking lever, co-operable with a pawl.

18. The fall arrest device according to claim 17, wherein the locking lever is lockable against the pawl by means of a detente button, depression of which releases permits the lever to be released therefrom.
